(19) United States
(12) Patent Application Publication
(10) Pub. No.: US 2026/0058208 A1
(43) Pub. Date: Feb. 26, 2026

(54) ELECTROLYTE COMPOSITION FOR LITHIUM SECONDARY BATTERY AND LITHIUM SECONDARY BATTERY CONTAINING THE SAME

(71) Applicants: Hyundai Motor Company, Seoul (KR); Kia Corporation, Seoul (KR); Pusan National University Industry-University Cooperation Foundation, Busan (KR)

(72) Inventors: Yoon Sung Lee, Hwaseong (KR); Sung Ho Ban, Hwaseong (KR); Yongho Lee, Hwaseong (KR); Huibeom Nam, Hwaseong (KR); Jae Bin Park, Busan (KR); Jin Hong Lee, Busan (KR); Taewoong Lee, Busan (KR); Pilgun Oh, Busan (KR); Jae Hong Choi, Busan (KR)

(21) Appl. No.: 18/965,265

(22) Filed: Dec. 2, 2024

(30) Foreign Application Priority Data
Aug. 23, 2024 (KR) 10-2024-0113470

(51) Int. Cl. H01M 10/0569; H01M 4/02; H01M 4/38; H01M 10/0525; H01M 10/0568

(52) U.S. Cl. CPC H01M 10/0569; H01M 4/382; H01M 10/0525; H01M 10/0568; H01M 2004/027; H01M 2300/0037

(57) ABSTRACT

An electrolyte composition for lithium secondary batteries includes a lithium salt and an organic solvent. The organic solvent includes a first ether solvent with a structure represented by R—O—R′, where R is a fluorine-substituted C1-2 alkyl and R′ is an unsubstituted C1-3 alkyl and may also include a second ether solvent. The first ether solvent may include methyl 1,1,2,2-tetrafluoroethyl ether, ethyl 1,1,2,2-tetrafluoroethyl ether, or a combination thereof, in a concentration of about 30 to 90 vol % of the total electrolyte composition. The lithium salt may include one or more compounds from a specific group and be present at a molarity of approximately 0.1 M to 3.0 M. This electrolyte composition is also compatible with lithium metal secondary batteries containing lithium metal anodes, offering improved performance and stability.

### CROSS-REFERENCE TO RELATED APPLICATION

This present application claims the benefit of Korean Patent Application No. 10-2024-0113470, entitled “ELECTROLYTE COMPOSITION FOR LITHIUM SECONDARY BATTERY AND LITHIUM SECONDARY BATTERY CONTAINING SAME,” filed on Aug. 23, 2024, in the Korean Intellectual Property Office, the entire disclosure of which is incorporated herein by reference.

### BACKGROUND

### Technical Field

The present disclosure relates to an electrolyte composition for a lithium secondary battery and a lithium secondary battery including the same.

### Background

In general, a lithium secondary battery has higher operating voltage and greater energy density than lead-acid or nickel/cadmium batteries due to its use of an electroactive material. Consequently, lithium secondary batteries are gaining attention as an energy storage solutions for electric vehicles (EVs) and hybrid electric vehicle (HEVs).

In order to improve the mileage of the electric vehicle, achieving high battery energy density is essential. To attain this, the capacity of the positive and negative electrode materials must be increased, or the battery operating voltage needs to be improved.

In order to increase the battery operating voltage, the oxidation stability of the electrolyte is a very important factor. Generally, as non-aqueous organic solvents, carbonates, esters, ethers or ketones are used alone or in combination. However, carbonate-based organic solvents are flammable organic materials, which can lead to side reactions and the dendrite formation with lithium metal. Consequently, when using the carbonate-based organic solvents as electrolytes, there is concern that battery safety may be vulnerable. In addition, because the carbonate-based organic solvents have a low flash point and high volatility, the carbonate-based organic solvents cause a combustion reaction with the electrode material when the carbonate-based organic solvents are used at high temperatures to rapidly increase the battery temperature, thereby ultimately causing a thermal runaway phenomenon. Therefore, the development of stable electrolytes may be a key factor for improving the energy density of lithium secondary batteries.

### SUMMARY

An aspect of the present disclosure is to provide an electrolyte having improved flame retardancy.

Another aspect of the present disclosure is to provide a lithium secondary battery having improved life characteristics.

Yet another aspect of the present disclosure is to provide a lithium secondary battery having improved output characteristics.

An aspect of the present disclosure is to provide an electrolyte composition for a lithium secondary battery that can be applied to green technology fields using batteries such as electric vehicles.

In order to achieve the aspects, the present disclosure provides an electrolyte composition for a lithium secondary battery, including a lithium salt; and an organic solvent, in which the organic solvent includes a first ether solvent of the following Chemical Formula 1 and a second ether solvent.

R—O—R [Chemical Formula 1]

In Chemical Formula 1, R is C₁₋₂ alkyl substituted with fluorine F; and R′ is unsubstituted C₁₋₃ alkyl.

In aspects, the first ether solvent and the second ether solvent are different chemical entities, although both will have at least one ether moiety.

In one embodiment of the present disclosure, the first ether solvent may include methyl 1,1,2,2-tetrafluoroethyl ether, ethyl 1,1,2,2-tetrafluoroethyl ether, or a combination thereof.

In one embodiment of the present disclosure, the second ether solvent may include at least one selected from the group consisting of dimethoxyethane, diethyl ether, dipropyl ether, methyl ethyl ether, methyl propyl ether and ethyl propyl ether, dibutyl ether, tetraglyme, diglyme, dimethyl ether, 2-methyl tetrahydrofuran, and tetrahydrofuran.

In one embodiment of the present disclosure, the lithium salt may include at least one selected from the group consisting of Li(CF₃SO₂)₂N(LiTFSI), Li(SO₂F)₂N(LiFSI), LiPF₆, LiBF₄, LiClO₄, LiCl, LiBr, LiI, LiB₁₀Cl₁₀, LiCF₃SO₃, LiCF₃CO₂, LiAsF₆, LiSbF₆, LiAlCl₄, CH₃SO₃Li, CF₃SO₃Li, LiN(SO₂C₂F₅)₂, Li(CF₃SO₂)₂N, LiC₄F₉SO₃, and LiB(C₆H₅)₄.

In one embodiment of the present disclosure, the electrolyte composition for the lithium secondary battery may include the first ether solvent in an amount of 30 to 90 vol % based on the total volume of the electrolyte composition.

In one embodiment of the present disclosure, the molarity of the lithium salt may be 0.1 M to 3.0 M.

Another aspect of the present disclosure provides a lithium secondary battery including the electrolyte composition for the lithium secondary battery.

Yet another aspect of the present disclosure provides a lithium metal secondary battery including: a positive electrode containing a positive active material; a negative electrode containing a lithium metal; a separator disposed between the positive electrode and the negative electrode; and an electrolyte, in which the electrolyte includes the electrolyte composition for the lithium secondary battery.

According to an embodiment of the present disclosure, an electrolyte composition for a lithium secondary battery comprises a lithium salt and an organic solvent that includes methyl 1,1,2,2-tetrafluoroethyl ether. The organic solvent may further include a second ether solvent. The second ether solvent may consist of one or more options selected from dimethoxyethane, diethyl ether, dipropyl ether, methyl ethyl ether, methyl propyl ether, ethyl propyl ether, dibutyl ether, tetraglyme, diglyme, dimethyl ether, 2-methyl tetrahydrofuran, and tetrahydrofuran. The lithium salt may consist of one or more options chosen from Li(CF3SO2)2N(LiTFSI), Li(SO2F)2N(LiFSI), LiPF6, LiBF4, LiClO4, LiCl, LiBr, LiI, LiB10C110, LiCF3SO3, LiCF3CO2, LiAsF6, LiSbF6, LiAlCl4, CH3SO3Li, CF3SO3Li, LiN(SO2C2F5)2, Li(CF3SO2)2N, LiC4F9SO3, and LiB(C6H5)4. Methyl 1,1,2,2-tetrafluoroethyl ether may be present in an amount of about 30 to 90 vol % based on the total volume of the electrolyte composition. The molarity of the lithium salt may range from about 0.1 M to 3.0 M.

According to an embodiment of the present disclosure, an electrolyte composition for a lithium secondary battery may comprise a lithium salt chosen from Li(CF3SO2)2N(LiTFSI), Li(SO2F)2N(LiFSI), LiPF6, LiBF4, LiClO4, LiCl, LiBr, LiI, LiB10C110, LiCF3SO3, LiCF3CO2, LiAsF6, LiSbF6, LiAlCl4, CH3SO3Li, CF3SO3Li, and an organic solvent that includes a first ether solvent represented by the chemical formula R—O—R′, where R is a fluorine-substituted C1-2 alkyl, and R′ is an unsubstituted C1-3 alkyl. The organic solvent may additionally include a second ether solvent. The second ether solvent may be selected from dimethoxyethane, diethyl ether, dipropyl ether, methyl ethyl ether, methyl propyl ether, ethyl propyl ether, dibutyl ether, tetraglyme, diglyme, dimethyl ether, 2-methyl tetrahydrofuran, and tetrahydrofuran. The first ether solvent may comprise methyl 1,1,2,2-tetrafluoroethyl ether, ethyl 1,1,2,2-tetrafluoroethyl ether, or a combination of both. The first ether solvent may be present in an amount of about 30 to 90 vol % based on the total volume of the electrolyte composition. The molarity of the lithium salt may range from about 0.1 M to 3.0 M.

According to an embodiment of the present disclosure, it is possible to improve the flame retardancy of the electrolyte for the lithium secondary battery.

According to another aspect of the present disclosure, it is possible to improve the charge/discharge life characteristics of the lithium secondary battery.

According to yet another aspect of the present disclosure, it is possible to reduce the cell resistance of the lithium secondary battery.

As discussed, the method and system suitably include use of a controller or processer.

In another embodiment, vehicles are provided that comprise an apparatus as disclosed herein.

### BRIEF DESCRIPTION OF THE DRAWINGS

The above and other aspects, features, and advantages of the present disclosure will become apparent from the detailed description of the following aspects in conjunction with the accompanying drawings, in which:

FIG. 1 is a diagram illustrating results of measuring the life characteristics of lithium secondary batteries including electrolyte compositions according to Example of the present disclosure and Comparative Examples; and

FIG. 2 is a diagram illustrating results of measuring the discharge capacity according to a C-rate of lithium secondary batteries including electrolyte compositions according to Example of the present disclosure and Comparative Example.

### DETAILED DESCRIPTION OF SPECIFIC EMBODIMENTS

Hereinafter, the present disclosure will be described in more detail. However, the following specific embodiments or examples are only a reference for explaining the present disclosure in detail, and the present disclosure is not limited thereto, and may be implemented in various forms.

Further, unless otherwise defined, all technical and scientific terms have the same meaning as commonly understood by those skilled in the art to which the present disclosure pertains.

The terminology used in the description herein is merely to effectively describe specific embodiments and is not intended to limit the present disclosure.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules, and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

In addition, as used in the specification and the appended claims, the singular forms may be intended to include plural forms, unless clearly dictated in the contexts otherwise.

In addition, units used in this specification without special mention are based on weight, and for example, units of % or ratio mean wt % or weight ratio, and wt % means wt % of any one component in the entire composition, unless otherwise defined.

Further, unless explicitly described to the contrary, when any part “comprises” any component, it will be understood to further include other components rather than excluding other components.

In addition, the numerical ranges used herein may include lower and upper limits and all values within that range, increments logically derived from the shape and width of the defined range, all doubly defined values, and all possible combinations of upper and lower limits of numerical ranges defined in different shapes. Unless otherwise specifically defined in the specification of the present disclosure, values out of the numerical range that may arise due to experimental error or rounding of values are also included in the defined numerical range.

As used herein, the “substituted” means that all or part of the hydrogen atoms of a substituted moiety (e.g., alkyl) are replaced with a substituent, and the “unsubstituted” means that not all of the hydrogen atoms contained in the alkyl are replaced with a substituent.

The “alkyl” as used herein may be either linear (straight-chain) or branched. Hereinafter, the present disclosure will be described in more detail.

The present disclosure relates to an electrolyte composition for a lithium secondary battery including an ether solvent substituted with fluorine and a lithium secondary battery including the same. The ether solvent substituted with fluorine may provide flame retardancy to an electrolyte while suppressing side reactions between a negative electrode and the electrolyte, thereby improving the safety, life characteristics, and battery performance of the lithium secondary battery.

The present disclosure provides an electrolyte composition for a lithium secondary battery, including a lithium salt; and an organic solvent, in which the organic solvent includes a first ether solvent of the following Chemical Formula 1 and a second ether solvent.

R—O—R′ [Chemical Formula 1]

In Chemical Formula 1, R may be C₁₋₂ alkyl substituted with fluorine F, specifically, C₂ alkyl substituted with fluorine F; and R′ may be unsubstituted C₁₋₃ alkyl, specifically, unsubstituted C₁₋₂ alkyl.

The first ether solvent may be a solvent having a lower ability of dissociating the lithium salt compared to the second ether solvent. More specifically, the first ether solvent may be a solvent having a dissociation ability such that a precipitate is observed with the naked eye when the first ether solvent is used alone in the lithium salt. In addition, the second ether solvent may be a solvent having a dissociation ability such that no precipitate is observed with the naked eye when the second ether solvent is used alone for the lithium salt. The first ether solvent may form a stable protective film on the electrode surface to suppress a continuous decomposition reaction of a bulk electrolyte, and the fluorine radicals generated in the following series of reaction formulas may play a role in terminating a chain reaction during the combustion process to reduce the combustion time when the electrolyte composition is exposed to a flame, thereby imparting flame retardancy to the electrolyte composition.

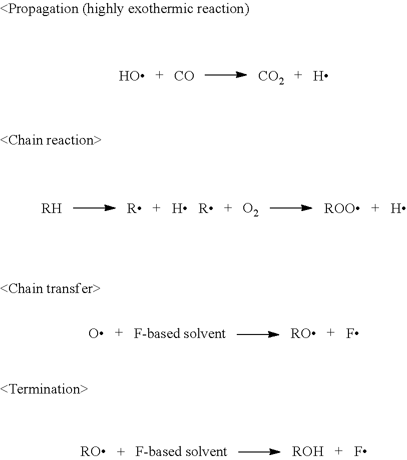

The first ether solvent may suppress side reactions between the second ether solvent, which is a lithium dissociative solvent, and the negative electrode of the lithium secondary battery. In addition, the first ether solvent has a low freezing point to expand the usable temperature range of the lithium secondary battery.

In one embodiment of the present disclosure, the first ether solvent of the above Chemical Formula 1 may include methyl 1,1,2,2-tetrafluoroethyl ether, ethyl 1,1,2,2-tetrafluoroethyl ether or a combination thereof, and specifically may include methyl 1,1,2,2-tetrafluoroethyl ether. The methyl 1,1,2,2-tetrafluoroethyl ether may be expressed by the following Structural Formula 1.

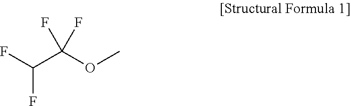

In one embodiment of the present disclosure, the second ether solvent may include at least one selected from the group consisting of dimethoxyethane, diethyl ether, dipropyl ether, methyl ethyl ether, methyl propyl ether and ethyl propyl ether, dibutyl ether, tetraglyme, diglyme, dimethyl ether, 2-methyl tetrahydrofuran, and tetrahydrofuran, and specifically dimethoxyethane, but is not limited thereto.

In one embodiment of the present disclosure, the lithium salt may include at least one selected from the group consisting of Li(CF₃SO₂)₂N(LiTFSI), Li(SO₂F)₂N(LiFSI), LiPF₆, LiBF₄, LiClO₄, LiCl, LiBr, LiI, LiB₁₀Cl₁₀, LiCF₃SO₃, LiCF₃CO₂, LiAsF₆, LiSbF₆, LiAlCl₄, CH₃SO₃Li, CF₃SO₃Li, LiN(SO₂C₂F₅)₂, Li(CF₃SO₂)₂N, LiC₄F₉SO₃, and LiB(C₆H₅)₄, and specifically Li(CF₃SO₂)₂N, but is not limited thereto as long as the purpose of the present disclosure may be achieved.

In one embodiment of the present disclosure, the molarity of the lithium salt may be 0.1 M to 3.0 M, specifically 0.5 M to 2.5 M, and more specifically 1.0 M to 2.0 M. When the range is satisfied, it is easy to secure ionic conductivity suitable for battery operation, the mobility of lithium ions is excellent, and the decomposition reaction of the lithium salt itself may be suppressed.

In one embodiment of the present disclosure, the electrolyte composition for the lithium secondary battery may include the first ether solvent in an amount of 30 to 90 vol %, specifically 40 to 80 vol %, and more specifically 50 to 70 vol %, based on the total volume of the electrolyte composition. When the range is satisfied, while the flame retardancy and life characteristics of the battery may be improved, excellent output characteristics may be exhibited.

Further, the present disclosure provides a lithium secondary battery including the electrolyte composition for the lithium secondary battery.

The description of the electrolyte composition for the lithium secondary battery is the same as described above and thus will be omitted.

In one embodiment of the present disclosure, the lithium secondary battery may further include a negative electrode, a positive electrode, and a separator interposed between the negative electrode and the positive electrode, in addition to the electrolyte composition for the lithium secondary battery described above.

The materials of the negative electrode, the positive electrode, and the separator are not particularly limited in the present disclosure and materials known in the art may be adopted. Specific examples are as follows.

In one embodiment of the present disclosure, the positive electrode and the negative electrode may be manufactured by mixing and stirring a solvent, a binder, a conductive agent, a dispersant, etc., as needed, with a positive active material and a negative active material, respectively, to prepare a mixture, then applying the mixture to a current collector made of a metal material, and then drying and pressing the mixture.

In one embodiment of the present disclosure, as the positive active material, any active material commonly used in the positive electrode of the lithium secondary battery may be used. For example, the positive active material may include lithium metal oxide particles including one or two or more metals selected from the group consisting of Ni, Co, Mn, Na, Mg, Ca, Ti, V, Cr, Cu, Zn, Ge, Sr, Ag, Ba, Zr, Nb, Mo, Al, Ga, B, and combinations thereof.

As the negative active material, any active material commonly used in the negative electrode of the lithium secondary battery may be used. As the negative active material of the lithium secondary battery, a material capable of lithium intercalation may be preferable. In one embodiment of the present disclosure, the negative active material may be one or two or more materials selected from the group of negative active materials of lithium (metallic lithium), graphitizable carbon, non-graphitizable carbon, graphite, silicon, Sn alloy, Si alloy, Sn oxide, Si oxide, Ti oxide, Ni oxide, Fe oxide (FeO), and lithium-titanium oxide (LiTiO₂, and Li₄Ti₅O₁₂).

In one embodiment of the present disclosure, a conventional conductive carbon material may be used as the conductive material without any particular limitation.

In one embodiment of the present disclosure, the current collector of the metal material may be any metal that has high conductivity and to which the mixture of the positive or negative active material can easily adhere, as long as there is no reactivity within the voltage range of the battery. Non-limiting examples of the positive current collector include foils made of aluminum, nickel, or a combination thereof, and the like, and non-limiting examples of the negative current collector may be selected from foils made of copper, gold, nickel, or a copper alloy, or a combination thereof, and the like.

In one embodiment of the present disclosure, the separator is a separator formed with micropores through which ions may pass, and a non-limiting example thereof may be a combination of one or two or more selected from the group consisting of glass fiber, polyester, polyethylene, polypropylene, and polytetrafluoroethylene, and may be in the form of a non-woven fabric or a woven fabric. Specifically, in the lithium secondary battery, a polyolefin polymer separator such as polyethylene and polypropylene may be mainly used but is not limited thereto. In addition, a separator coated with a composition containing a ceramic component or a polymer material may also be used to secure heat resistance or mechanical strength and may selectively be used in a single-layer or multi-layer structure, and separators known in the art may be used, but are not limited thereto.

In one embodiment of the present disclosure, the appearance of the lithium secondary battery is not particularly limited but may be selected from a cylindrical shape using a can, a square shape, a pouch shape, or a coin shape.

Further, the present disclosure provides a lithium metal secondary battery including: a positive electrode containing a positive active material; a negative electrode containing a lithium metal; a separator disposed between the positive electrode and the negative electrode; and an electrolyte, in which the electrolyte includes the electrolyte composition for the lithium secondary battery.

The contents of the electrolyte composition for the lithium secondary battery and the lithium secondary battery described above may also be equally applied to a lithium metal secondary battery within a duplicated range.

Hereinafter, preferable Example of the present disclosure and Comparative Examples will be described. However, the following Examples are merely a preferred embodiment of the present disclosure, and the present disclosure is not limited to the following Examples.

### Experimental Example 1: Evaluation of Ionic Conductivity and Dissociation

First, the ionic conductivity and dissociation were evaluated according to the content of a lithium salt and the mixing amount of a solvent in an electrolyte composition. To this end, an electrolyte composition for a lithium secondary battery was prepared with a composition shown in Table 1 below.

Ionic conductivity was measured using a three-electrode impedance technique using two 0.5×0.5 cm Pt plates as working/counter electrodes and a 0.5 mm-diameter Pt wire as a reference electrode in a glove box with moisture and oxygen concentrations of 0.1 ppm or less, respectively, and a calibration curve was prepared using a KCl aqueous solution for impedance measurement.

The presence or absence of non-dissociation was evaluated by visually confirming whether there was a precipitate.

The evaluation results of the ionic conductivity and dissociation were as follows.

TABLE 1

| | | | | | Second | First | | |
|---|---|---|---|---|---|---|---|---|
| | | | Carbonate | | ether | ether | | |
| | | | solvent | | solvent | solvent | Ionic | |
| | Lithium salt (M) | | (vol %) | | (vol %) | (vol %) | conductivity | Non- |
| | LiPF₆ | LiTFSI | EC | EMC | DME | MTFEE | (mS/cm) | dissociation |
| Com. Ex. 1 | 1.0 | — | 50 | 50 | — | — | 9.1 | X |
| Com. Ex. 2 | — | 1.0 | 50 | 50 | — | — | 8.7 | X |
| Com. Ex. 3 | — | 1.0 | — | — | — | 100 | 1.8 | ◯ (Non- |
| | | | | | | | | dissociation) |
| Com. Ex. 4 | — | 1.0 | — | — | 100 | — | 8.4 | X |
| Ex. 1 | — | 1.0 | — | — | 50 | 50 | 5.9 | X |
| Ex. 2 | — | 1.5 | — | — | 50 | 50 | 6.6 | X |
| Ex. 3 | — | 2.0 | — | — | 50 | 50 | 6.8 | X |
| Ex. 4 | — | 2.5 | — | — | 50 | 50 | 4.1 | X |
| Ex. 5 | — | 3.0 | — | — | 50 | 50 | 3.2 | X |

(1) LiPF₆: Lithium hexafluorophosphate
(2) LiTFSI: Lithium bis(trifluoromethanesulfonyl)imide
(3) EC: Ethylene carbonate
(4) EMC: Ethyl methyl carbonate
(5) DME: Dimethoxy ethane
(6) MTFEE: Methyl 1,1,2,2-tetrafluoroethyl ether

Referring to Table 1, when the first ether solvent was included in 100 vol % as in Comparative Example 3, the lithium salt was not dissociated. Accordingly, the number of dissociated free ions was small, resulting in a very low ionic conductivity of 1.8. Therefore, it can be seen that it is disadvantageous to use only the first ether solvent as a solvent.

Meanwhile, when the second ether solvent was included in 100 vol % as in Comparative Example 4, very high ionic conductivity was shown. However, when only the second ether solvent was used, it was disadvantageous to the electrode performance due to the reaction with the lithium metal negative electrode.

The ionic conductivity and non-dissociation of electrolyte compositions, in which the molarities of lithium salts was increased to 1.0, 1.5, 2.0, 2.5, and 3.0 M, respectively, were evaluated, as in Examples 1 to 5. As a result, the best ionic conductivity was observed when the molarity of the lithium salt was 2.0 M. Therefore, in Experimental Example 2 below, the molarity of the lithium salt was fixed at 2.0 M, and then various characteristic tests were conducted according to the mixing ratio of the first ether solvent and the second ether solvent.

### Experimental Example 2: Evaluation of Ionic Conductivity, Flame Retardancy, and Life Characteristics of Electrolyte Composition

### Evaluation of Ionic Conductivity

An electrolyte composition for a lithium secondary battery was prepared with a composition shown in Table 2 below. A method for evaluating the ionic conductivity of the electrolyte composition was performed in the same manner as in Experimental Example 1.

### Evaluation of Flame Retardancy

Meanwhile, in order to evaluate the flame retardancy, the electrolyte composition of Table 2 below was soaked in glass fiber, and a self-extinguishing time (SET) was measured, and the results were shown in Table 2 below. The SET represented the time until the electrolyte was ignited and then extinguished and considering that the combustion time varied depending on the weight of the electrolyte, the combustion time per weight (unit: sec/g) was introduced in the present disclosure.

### Evaluation of Life Characteristics

The life characteristics of a lithium secondary battery including an electrolyte composition with a composition shown in Table 2 below were evaluated as follows.

A negative electrode mixture slurry was prepared by mixing 96 wt % of graphite as a negative active material, 2 wt % of styrene-butadiene rubber (SBR) as a binder, and 2 wt % of carboxymethyl cellulose (CMC). The prepared negative electrode mixture slurry was applied to both sides of a lithium metal foil, dried, and then laminated to manufacture a negative electrode.

A positive electrode slurry was prepared by mixing LiNi₈₃Co₁₁Mn₆O₂ as a positive active material, poly(vinylidene fluoride) (PVdF) as a positive electrode binder, and super-P carbon as a conductive material in a weight ratio of 93:3:4, and then dispersing the mixture in N-methyl-2-pyrrolidone. Thereafter, the slurry was coated on an aluminum foil with a thickness of 30 μm and dried at a temperature of 80° C. to manufacture a positive electrode having a loading level of about 10.0 mg/cm². Then, a coin cell was manufactured using the manufactured positive electrode by a conventional method.

An electrode assembly was formed by interposing a 20 μm-thick polypropylene film between the manufactured negative electrode and positive electrode, and then 40 μl of the electrolyte composition according to Examples and Comparative Examples was injected to manufacture a pouch-type lithium secondary battery. All electrodes were prepared in a dry room, and the batteries were manufactured in a glove box maintained under an argon atmosphere.

The manufactured lithium secondary battery was charged under a constant current of 0.1 C rate at room temperature (25° C.) until the voltage reached 4.3 V (vs. Li), and then charged under a constant voltage by cutting off at a current of 0.01 C rate while maintaining 4.3 V in a constant voltage mode. The lithium secondary battery was discharged at a constant current of 0.1 C rate until the voltage reached 2.75 V (vs. Li). The charging and discharging were set as one cycle, and one more cycle of charging and discharging was performed in the same manner. Then, the applied current during charging and discharging was changed to 1.0 C and 100 cycles were performed with a 5-minute rest period between cycles. The life characteristics were measured by calculating the 100-cycle discharge capacity for the 1-cycle discharge capacity, and the results were shown in Table 2 below.

TABLE 2

| | | | | | Second | First | | Self- | | | |
|---|---|---|---|---|---|---|---|---|---|---|---|
| | | | Carbonate | | ether | ether | Ionic | extin- | 1 cycle | 100 cycle | Life |
| | | | solvent | | solvent | solvent | conduc- | guishing | discharge | discharge | charac- |
| | Lithium salt (M) | | (vol %) | | (vol %) | (vol %) | tivity | time | capacity | capacity | teristic |
| | LiPF₆ | LiTFSI | EC | EMC | DME | MTFEE | (mS/cm) | (sec/g) | (mAh/g) | (mAh/g) | (%) |
| Com. Ex. 1 | 1.0 | | 50 | 50 | | | 9.1 | 81 | 181.7 | 101.9 | 56.1 |
| Com. Ex. 5 | | 2.0 | 50 | 50 | | | 9.4 | 78 | 185.5 | 151.5 | 81.7 |
| Ex. 6 | | 2.0 | | | 70 | 30 | 7.3 | 56 | 182.1 | 168.1 | 92.3 |
| Ex. 7 | | 2.0 | | | 60 | 40 | 7.1 | 34 | 183.1 | 174.1 | 95.1 |
| Ex. 3 | | 2.0 | | | 50 | 50 | 6.8 | 28 | 186.2 | 176.2 | 94.6 |
| Ex. 8 | | 2.0 | | | 40 | 60 | 6.2 | 21 | 188.9 | 176.4 | 93.4 |
| Ex. 9 | | 2.0 | | | 30 | 70 | 5.8 | 13 | 192.1 | 183.1 | 95.3 |
| Ex. 10 | | 2.0 | | | 20 | 80 | 4.3 | 8 | 179.9 | 177.2 | 98.5 |

As can be seen in Table 2 above, it was confirmed that the electrolyte composition according to the present disclosure had a shortened self-extinguishing time as the content of the first ether solvent in the composition increased to improve the safety of a lithium secondary battery. In particular, significantly superior flame retardancy was shown compared to Comparative Examples 1 and 5.

In addition, compared to the lithium secondary batteries including the electrolyte compositions according to Comparative Examples 1 and 5, it can be confirmed that a lithium secondary battery using an electrolyte composition according to Example of the present disclosure has relatively excellent life characteristics by maintaining a capacity of about 92% or more compared to an initial capacity even after 100 cycles.

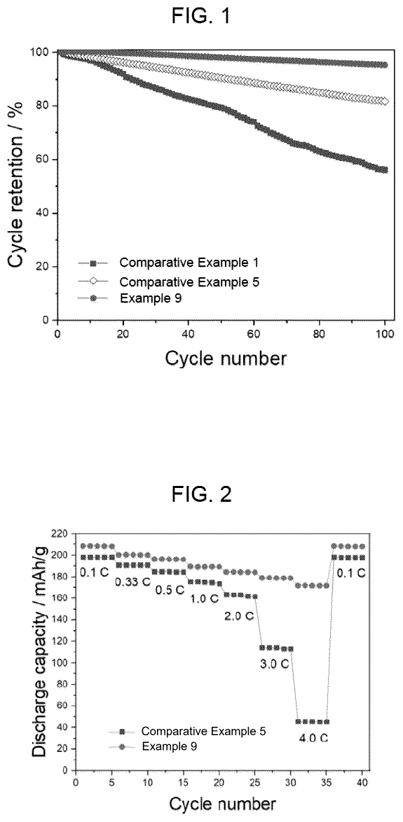

In particular, referring to FIG. 1, when comparing Example 9 and Comparative Examples 1 and 5, it can be confirmed that the life characteristics of Example are significantly high.

### Experimental Example 3: Evaluation of Output Characteristics of Lithium Secondary Battery

In order to evaluate the charge/discharge behavior of the lithium secondary batteries including the electrolyte compositions according to Example 3 and Comparative Example 5, the capacities of the batteries were measured by performing charge/discharge cycles five times each at C-rates of 0.1 C, 0.33 C, 0.5 C, 1.0 C, 2.0 C, 3.0 C, and 4.0 C in a voltage range of 2.75 to 4.3 V at room temperature (25° C.), and the results were shown in Table 3 and FIG. 2.

TABLE 3

| | Discharge capacity (mAh/g) | | | | | | | |
|---|---|---|---|---|---|---|---|---|
| | 0.1 C | 0.33 C | 0.5 C | 1.0 C | 2.0 C | 3.0 C | 4.0 C | 0.1 C |
| Com. Ex. 5 | 198 | 190 | 184 | 174 | 163 | 113 | 45 | 197 |
| Ex. 9 | 208 | 200 | 196 | 189 | 184 | 178 | 171 | 207 |

Referring to FIG. 2, in the case of the battery containing the electrolyte composition of Comparative Example above, the discharge capacity decreases rapidly at 3.0 C, but in the case of Example, similar discharge capacity values were maintained at each C-rate. That is, it was confirmed that the lithium secondary battery of Example including the electrolyte composition according to Example of the present disclosure may implement excellent capacity and output characteristics.

Features, structures, effects, and the like described in the above-described embodiments are included in at least one embodiment of the present disclosure and are not necessarily limited to one embodiment. Furthermore, the features, structures, effects, and the like illustrated in each embodiment can be combined or modified even in other embodiments by those of ordinary skill in the art to which the embodiments pertain. Accordingly, the contents related to these combinations and modifications should be interpreted to cover the scope of the present disclosure.

As described above, the embodiments have been mainly described but are only examples and do not limit the present disclosure, and those skilled in the art to which the present disclosure pertains will appreciate that various modifications and applications not illustrated above can be made without departing from the essential characteristics of the embodiments of the present disclosure. For example, each component specifically shown in embodiments can be modified and implemented. In addition, differences related to these modifications and applications should be construed as being included in the scope of the present disclosure defined in the appended claims.

What is claimed is:

1. An electrolyte composition for a lithium secondary battery, the electrolyte composition comprising:
a lithium salt; and
an organic solvent,
wherein the organic solvent comprises a first ether solvent of the following Chemical Formula 1 and a second ether solvent: 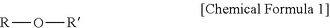
In Chemical Formula 1,
R is C₁₋₂ alkyl substituted with fluorine F; and
R′ is unsubstituted C₁₋₃ alkyl.

2. The electrolyte composition for the lithium secondary battery of claim 1, wherein the first ether solvent comprises methyl 1,1,2,2-tetrafluoroethyl ether, ethyl 1,1,2,2-tetrafluoroethyl ether, or a combination thereof.

3. The electrolyte composition for the lithium secondary battery of claim 1, wherein the second ether solvent comprises at least one selected from the group consisting of dimethoxyethane, diethyl ether, dipropyl ether, methyl ethyl ether, methyl propyl ether and ethyl propyl ether, dibutyl ether, tetraglyme, diglyme, dimethyl ether, 2-methyl tetrahydrofuran, and tetrahydrofuran.

4. The electrolyte composition for the lithium secondary battery of claim 1, wherein the lithium salt comprises at least one selected from the group consisting of Li(CF₃SO₂)₂N(LiTFSI), Li(SO₂F)₂N(LiFSI), LiPF₆, LiBF₄, LiClO₄, LiCl, LiBr, LiI, LiB₁₀C₁₁₀, LiCF₃SO₃, LiCF₃CO₂, LiAsF₆, LiSbF₆, LiAlCl₄, CH₃SO₃Li, CF₃SO₃Li, LiN(SO₂C₂F₅)₂, Li(CF₃SO₂)₂N, LiC₄F₉SO₃, and LiB(C₆H₅)₄.

5. The electrolyte composition for the lithium secondary battery of claim 1, wherein the first ether solvent is contained in an amount of about 30 to 90 vol % based on the total volume of the electrolyte composition.

6. The electrolyte composition for the lithium secondary battery of claim 1, wherein the molarity of the lithium salt is about 0.1 M to 3.0 M.

7. A lithium secondary battery comprising the electrolyte composition for the lithium secondary battery of claim 1.

8. A lithium metal secondary battery comprising:
a positive electrode containing a positive active material;
a negative electrode containing a lithium metal;
a separator disposed between the positive electrode and the negative electrode; and
an electrolyte,
wherein the electrolyte comprises the electrolyte composition for the lithium secondary battery of claim 1.

9. An electrolyte composition for a lithium secondary battery, the electrolyte composition comprising:
a lithium salt; and
an organic solvent comprising methyl 1,1,2,2-tetrafluoroethyl ether.

10. The electrolyte composition for the lithium secondary battery of claim 9, wherein the organic solvent further comprises a second ether solvent.

11. The electrolyte composition for the lithium secondary battery of claim 10, wherein the second ether solvent comprises at least one selected from the group consisting of dimethoxyethane, diethyl ether, dipropyl ether, methyl ethyl ether, methyl propyl ether and ethyl propyl ether, dibutyl ether, tetraglyme, diglyme, dimethyl ether, 2-methyl tetrahydrofuran, and tetrahydrofuran.

12. The electrolyte composition for the lithium secondary battery of claim 9, wherein the lithium salt comprises at least one selected from the group consisting of Li(CF₃SO₂)₂N(LiTFSI), Li(SO₂F)₂N(LiFSI), LiPF₆, LiBF₄, LiClO₄, LiCl, LiBr, LiI, LiB₁₀C₁₁₀, LiCF₃SO₃, LiCF₃CO₂, LiAsF₆, LiSbF₆, LiAlCl₄, CH₃SO₃Li, CF₃SO₃Li, LiN(SO₂C₂F₅)₂, Li(CF₃SO₂)₂N, LiC₄F, SO₃, and LiB(C₆H₅)₄.

13. The electrolyte composition for the lithium secondary battery of claim 9, wherein methyl 1,1,2,2-tetrafluoroethyl ether is contained in an amount of about 30 to 90 vol % based on the total volume of the electrolyte composition.

14. The electrolyte composition for the lithium secondary battery of claim 9, wherein the molarity of the lithium salt is about 0.1 M to 3.0 M.

15. An electrolyte composition for a lithium secondary battery, the electrolyte composition comprising:
lithium salt comprising at least one selected from the group consisting of Li(CF₃SO₂)₂N(LiTFSI), Li(SO₂F)₂N(LiFSI), LiPF₆, LiBF₄, LiClO₄, LiCl, LiBr, LiI, LiB₁₀C₁₁₀, LiCF₃SO₃, LiCF₃CO₂, LiAsF₆, LiSbF₆, LiAlCl₄, CH₃SO₃Li, CF₃SO₃Li; and
an organic solvent comprising a first ether solvent of the following Chemical Formula 1: 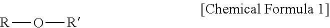
In Chemical Formula 1,
R is C₁₋₂ alkyl substituted with fluorine F; and
R′ is unsubstituted C₁₋₃ alkyl.

16. The electrolyte composition for the lithium secondary battery of claim 15, wherein the organic solvent further comprises a second ether solvent.

17. The electrolyte composition for the lithium secondary battery of claim 16, wherein the second ether solvent comprises at least one selected from the group consisting of dimethoxyethane, diethyl ether, dipropyl ether, methyl ethyl ether, methyl propyl ether and ethyl propyl ether, dibutyl ether, tetraglyme, diglyme, dimethyl ether, 2-methyl tetrahydrofuran, and tetrahydrofuran.

18. The electrolyte composition for the lithium secondary battery of claim 15, wherein the first ether solvent comprises methyl 1,1,2,2-tetrafluoroethyl ether, ethyl 1,1,2,2-tetrafluoroethyl ether, or a combination thereof.

19. The electrolyte composition for the lithium secondary battery of claim 15, wherein the first ether solvent is contained in an amount of about 30 to 90 vol % based on the total volume of the electrolyte composition.

20. The electrolyte composition for the lithium secondary battery of claim 15, wherein the molarity of the lithium salt is about 0.1 M to 3.0 M.
